(19) United States
(12) Patent Application Publication
(10) Pub. No.: US 2026/0357642 A1
(43) Pub. Date: Nov. 12, 2026

(54) SLIDABLE WINDOW ASSEMBLY FOR MULTI-DIRECTION INSTALLATION

(71) Applicant: Owen Woodruff Bunker, II, Denver, CO (US)

(72) Inventor: Owen Woodruff Bunker, II, Denver, CO (US)

(21) Appl. No.: 19/672,147

(22) Filed: May 8, 2026

Related U.S. Application Data
(60) Provisional application No. 63/803,141, filed on May 9, 2025.

(51) Int. Cl. E06B 3/44; E06B 3/46; E06B 7/28

(52) U.S. Cl. CPC E06B 3/4415; E06B 3/4609; E06B 2003/4484; E06B 7/28

(57) ABSTRACT

A convertible window assembly may include a frame, a sash slidably positionable within the frame, a guide disposed along a length of the frame and configured to guide slidable movement of the sash relative to the frame, and a switch configured to enable selective operation of the convertible window assembly as a horizontal slider window when the frame is in a horizontal orientation, and as a hung window when the frame is in a vertical orientation.

### CROSS-REFERENCE TO RELATED APPLICATIONS

This application claims benefit of U.S. Provisional Patent Application No. 63/803,141, entitled “SLIDABLE WINDOW ASSEMBLY FOR MULTI-DIRECTION INSTALLATION,” filed May 9, 2025, the contents of which are hereby incorporated by reference in their entirety.

### FIELD

This technology relates generally to window assemblies, and in particular, to convertible window assemblies that may be installed in multiple orientations.

### BACKGROUND

Windows are commonly used in a wide range of structures, including residential buildings, commercial spaces, and smaller utility structures such as sheds. Windows typically involve one or more framed structures (commonly referred to as “sashes”) that hold the glass panes and are fitted within the window frame. Oftentimes, one or more of the sashes may be slidable within the window frame. However, sashes in conventional windows are typically configured to slide in a single direction, either horizontally or vertically, which limits the installation of the window to a single orientation.

For example, hung windows are typically vertically oriented with multiple sashes stacked on top of each other. In single-hung windows, one sash (such as a bottom sash) slides vertically while another sash (such as a top sash) remains fixed in place. In double-hung windows, both the top and bottom sashes may slide vertically. And in triple-hung windows, three sashes slide vertically within the frame. Hung windows also often require features to restrict downward movement of the slidable sash due to gravity when it is raised vertically upward, such as counterbalances, springs, or friction mechanisms. Such features not only prevent the sash from unintentionally falling—which could damage the window, compromise its functionality, or pose safety risks to individuals nearby—but also secure the sash in a desired open position. By contrast, sliding windows are horizontally oriented, with one or more of the sashes sliding side-to-side within the frame, which eliminates the need for such gravity-countering mechanisms.

The limitations of conventional windows directly dictate the orientation in which the window must be installed, as a window designed for horizontal sliding cannot be easily adapted for vertical sliding, and vice versa. As a result, manufacturers are forced to produce separate and distinct designs for horizontal and vertical configurations, leading to increased manufacturing complexity and design costs.

In applications like sheds, for example, the limitations of conventional one-direction sliding windows may be particularly problematic. Sheds often have compact interiors with limited wall space, which demand adaptable solutions. For shed designers and manufacturers, having separate models for horizontal and vertical sliding windows limits the flexibility of shed designs, increases production complexity, and increases inventory costs. This limitation also requires an upfront evaluation and selection of an orientation-specific window that matches the shed's layout, adding inefficiency to the installation process. These inefficiencies not only drive up costs, but also hinder the ability to streamline manufacturing and installation processes.

### SUMMARY

Some embodiments of the present technology relate to convertible window assemblies. The convertible window assemblies may include a frame. The convertible window assemblies may include a sash slidably positionable within the frame. The convertible window assemblies may include a guide disposed along a length of the frame and configured to guide slidable movement of the sash relative to the frame. The convertible window assemblies may include a switch configured to enable selective operation of the convertible window assembly as a horizontal slider window when the frame is in a horizontal orientation, and as a hung window when the frame is in a vertical orientation.

In some embodiments, the guide may include a plurality of engagement features spaced along at least a portion of the length of the frame. The switch may include an engagement member movable between an engaged position and a disengaged position. In the engaged position, the engagement member may be configured to interact with at least one of the engagement features to restrict slidable movement of the sash in at least one direction along the length of the frame. In the disengaged position, slidable movement of the sash along the length of the frame may be unrestricted.

In some embodiments, in the engaged position, the engagement member may be configured to interact with at least one of the engagement features to restrict downward vertical sliding of the sash when the frame is in the vertical orientation.

In some embodiments, in the engaged position, the engagement member may protrude laterally outward relative to a body of the switch and contact the guide.

In some embodiments, in the disengaged position, horizontal sliding of the sash along the length of the frame may be unrestricted when the frame is in the horizontal orientation.

In some embodiments, the engagement member may be biased to interact with the guide.

In some embodiments, the switch may include a locking feature configured to selectively secure the engagement member in at least one of the engaged position and the disengaged position.

The convertible window assemblies may include a frame. The frame may include a plurality of frame members interconnected to define an opening. The convertible window assemblies may include a sash slidably positionable within the opening of the frame. The convertible window assemblies may include a guide disposed along at least a portion of an inner surface of at least one of the plurality of frame members. The guide may include a protruding member having a plurality of notches spaced along a length of the guide. The convertible window assemblies may include a switch removably coupleable to the sash. The switch may be configured to enable selective operation of the convertible window assembly as a horizontal slider window when the frame is in a horizontal orientation and as a hung window when the frame is in a vertical orientation. The switch may be configured to selectively operate in an engaged position and a disengaged position. In the engaged position, the switch may be configured to interact with at least one of the notches to restrict slidable movement of the sash in at least one direction along the length of the frame. In the disengaged position, the switch may be disengaged from the guide so as to allow unrestricted slidable movement of the sash along the length of the frame.

In some embodiments, the plurality of frame members may include a first frame member and a second frame member parallel to the first frame member. The guide may include a first guide member disposed along at least a portion of an inner surface of the first frame member, and a second guide member disposed along at least a portion of an inner surface of the second frame member. The switch may include a first switch removably coupleable to the sash proximate the first guide, and a second switch removably coupleable to the sash proximate the second guide.

In some embodiments, in the engaged position, the switch may be configured to interact with at least one of the notches to restrict downward vertical sliding of the sash when the frame is in the vertical orientation.

In some embodiments, in the disengaged position, horizontal sliding of the sash along the length of the frame may be unrestricted when the frame is in the horizontal orientation.

In some embodiments, the switch may be biased to contact the guide.

In some embodiments, the switch may be spring-loaded.

In some embodiments, the switch may include a switch housing removably coupleable to the sash and a user-actuated member movably positioned within the switch housing. The user-actuated member may be movable relative to the switch housing between the engaged position and the disengaged position. The user-actuated member may be biased to contact the guide.

In some embodiments, the switch may include a locking feature configured to selectively secure the switch in at least one of the engaged position and the disengaged position.

In some embodiments, the locking feature may include a rotatable lock configured to secure the switch in at least one of the engaged position and the disengaged position.

In some embodiments, each of the plurality of notches may include a planar surface extending laterally relative to the guide and an angled surface extending from the planar surface in a longitudinal direction relative to the guide.

In some embodiments, the convertible window assemblies may further include a plurality of drainage holes positioned proximate adjacent ends of the plurality of frame members.

In some embodiments, the guide may be removably insertable within the frame.

In some embodiments, the guide may be integral to the frame.

### BRIEF DESCRIPTION OF THE DRAWINGS

A further understanding of the nature and advantages of the disclosed technology may be realized by reference to the remaining portions of the specification and the drawings.

FIG. 1A is a perspective view of a convertible window assembly in a vertical orientation, according to some embodiments of the present technology.

FIG. 1B is a detail view of a switch and a guide of the convertible window assembly of FIG. 1A, according to some embodiments of the present technology.

FIGS. 1C-E are detailed views of the switch interacting with the guide at different sliding positions of the convertible window assembly of FIG. 1A, according to some embodiments of the present technology.

FIGS. 1F-I are different sliding positions of the convertible window assembly of FIG. 1A, according to some embodiments of the present technology.

FIG. 1J is a bottom view of the switch and the guide of the convertible window assembly of FIG. 1B, according to some embodiments of the present technology.

FIG. 2A is a perspective view of the convertible window assembly of FIG. 1A in a horizontal orientation, according to some embodiments of the present technology.

FIGS. 2B-D are detailed views of a switch of the convertible window assembly of FIG. 2A in a disengaged position, according to some embodiments of the present technology.

### DETAILED DESCRIPTION

The subject matter of embodiments of the present technology is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Further, while embodiments of the present technology may be discussed in the context of sheds and similar utility structures, it should be appreciated that the claimed subject matter may be utilized in a wide range of structures, including but not limited to residential structures (e.g., homes, apartment buildings), commercial structures (e.g., office buildings, retail stores), utility structures (e.g., barns, greenhouses, garages, workshops), recreational structures (e.g., campers), vehicles (e.g., boats, RVs, trailers, busses, trains), and/or other suitable structures.

Embodiments of the present technology are directed to convertible window assemblies for multi-direction installation. These window assemblies may provide solutions that enable a single window assembly to selectively operate both as a horizontal sliding window in a horizontal orientation and as a vertical hung window in a vertical orientation. For example, the slidable window assemblies may include a switch configured to enable selective operation of the convertible window assembly as a horizontal slider window and as a hung window. The slidable window assemblies may also include a guide configured to direct slidable movement of a sash, and the guide may have a plurality of engagement features (e.g., notches) configured to interact with the switch. The switch may be selectively switchable between an engaged position and a disengaged position. In the engaged position, the switch may contact or otherwise engage with one or more of the engagement features of the guide to limit movement of the sash in one or more sliding directions, and in the disengaged position, the switch may be moved out of contact and/or otherwise disengaged with the one or more engagement features such that movement of the sash is unrestricted.

Thus, for example, when the window assembly is in a vertical orientation, the switch may be switched to the engaged position, allowing the switch to physically interact with the one or more engagement features, thereby limiting downward movement of the sash while allowing the sash to be raised upwardly. The switch may also include one or more features to selectively switch to the disengaged position to allow the sash to be lowered in the vertical orientation. When the window assembly is in a horizontal orientation, the switch may be switched to the disengaged position or removed or omitted from the window assembly, preventing the switch from interacting with the one or more engagement features, thereby enabling unrestricted side-to-side movement of the sash. Because the convertible window assembly may be configured to operate in both horizontal and vertical orientations, the need for separate horizontal and vertical window designs may be eliminated.

In applications like sheds, for example, these features may provide shed manufacturers and their customers with greater flexibility in design choices, allowing them to optimize ventilation, natural light, and accessibility to suit their specific structural layout configurations. Additionally, by eliminating the need for separate horizontal and vertical window designs, shed manufacturers may also utilize a single, versatile window assembly that works across multiple shed models. This versatility may reduce inventory costs and may streamline installation, while offering a more adaptable product that appeals to a broad customer base.

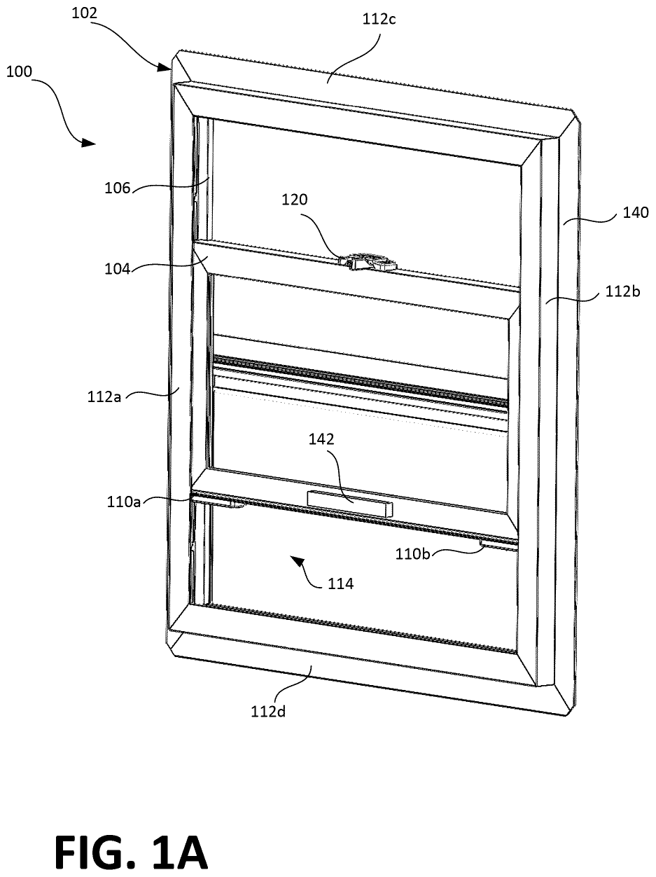

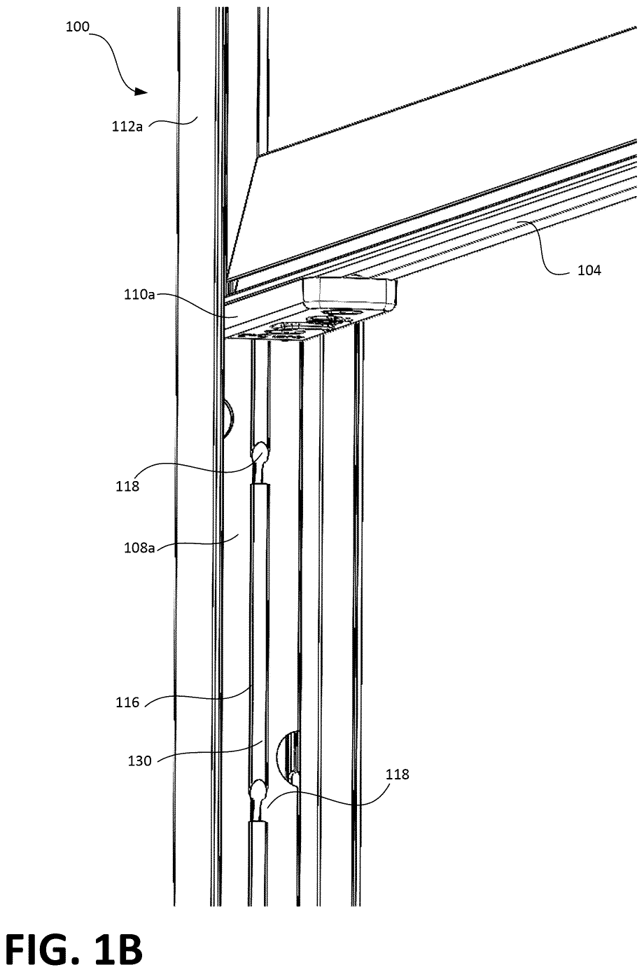

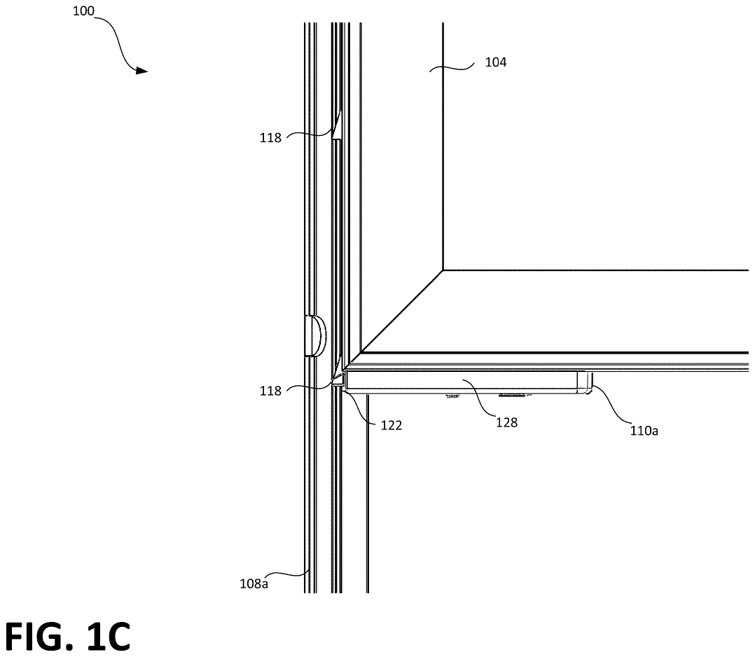

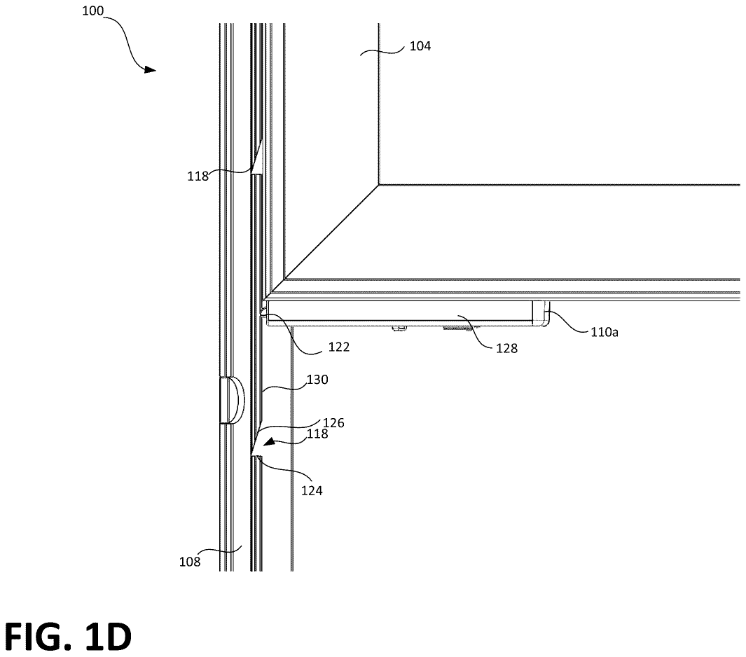

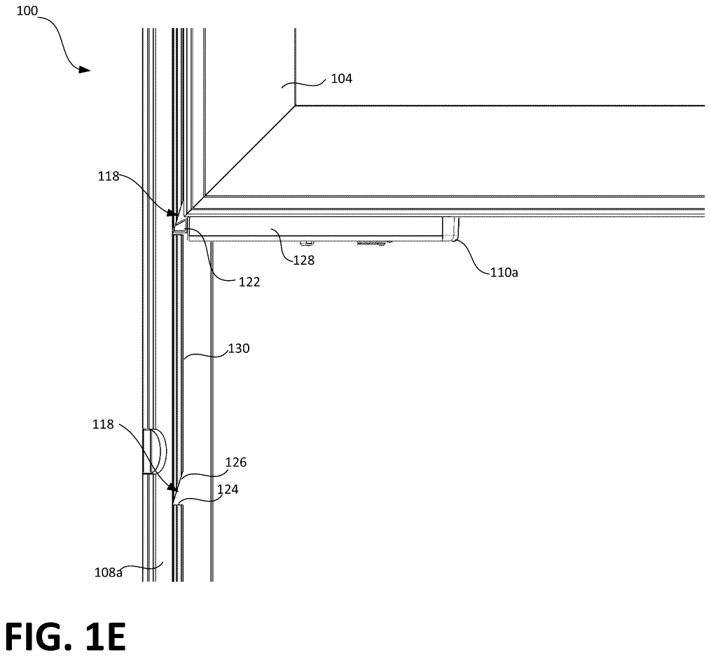

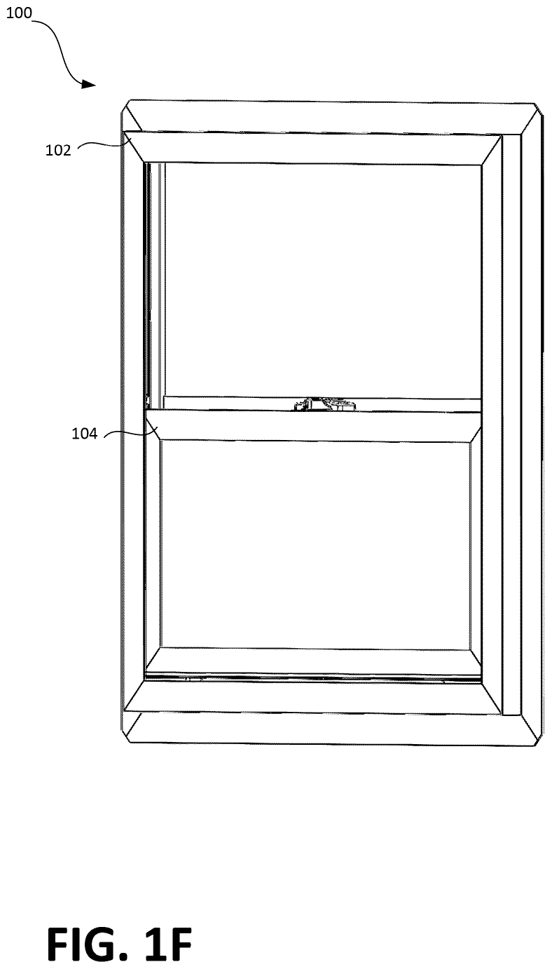

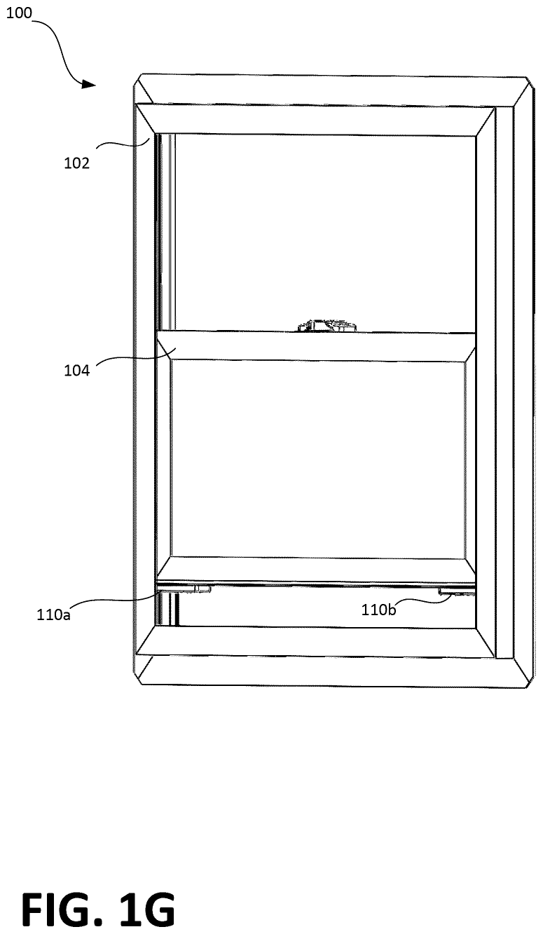

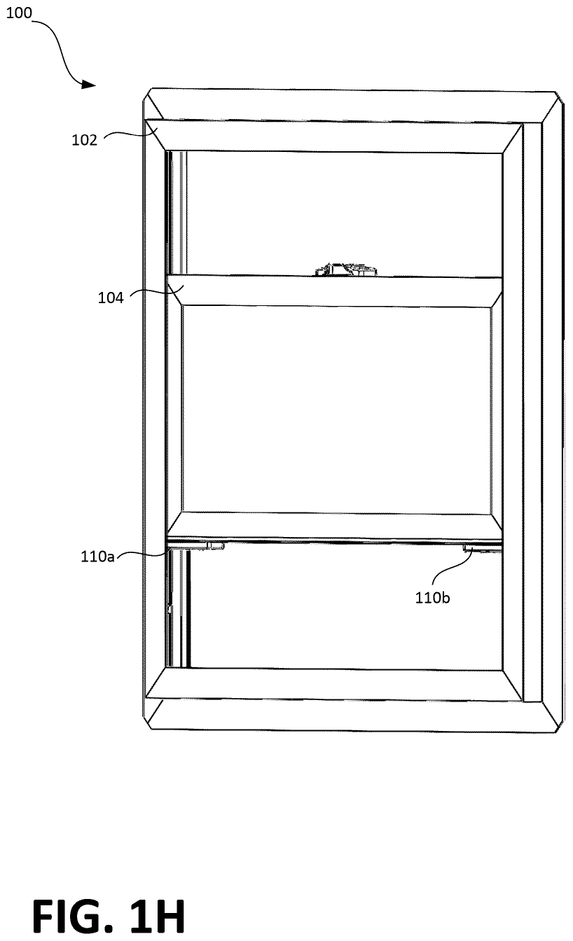

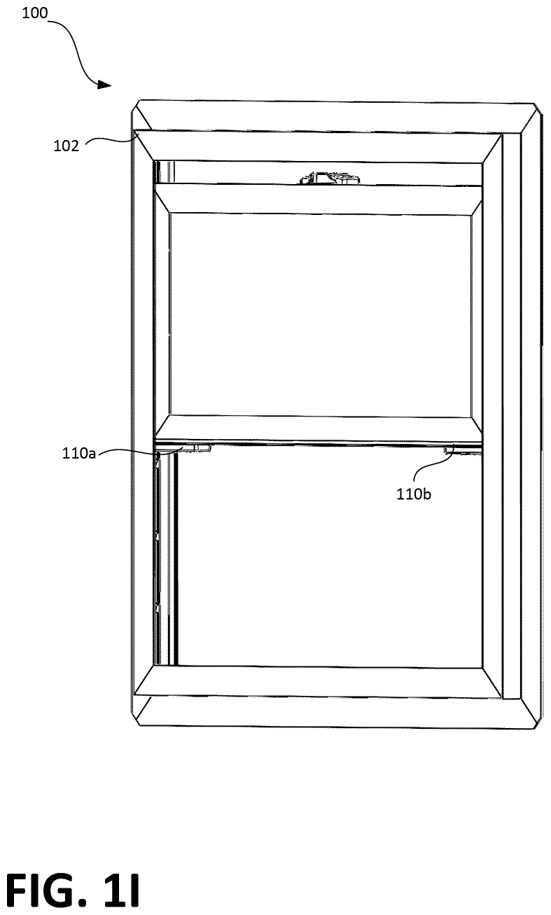

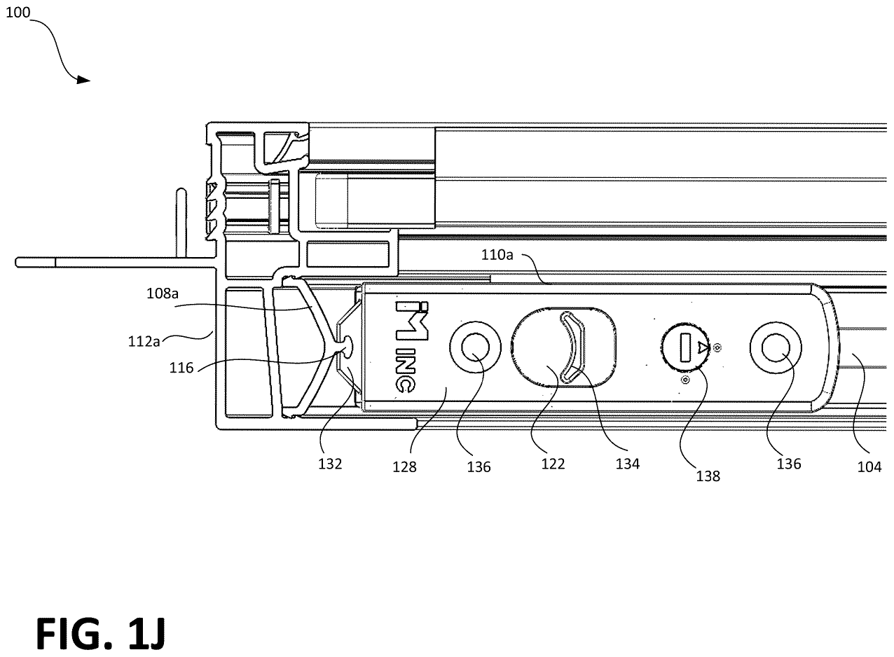

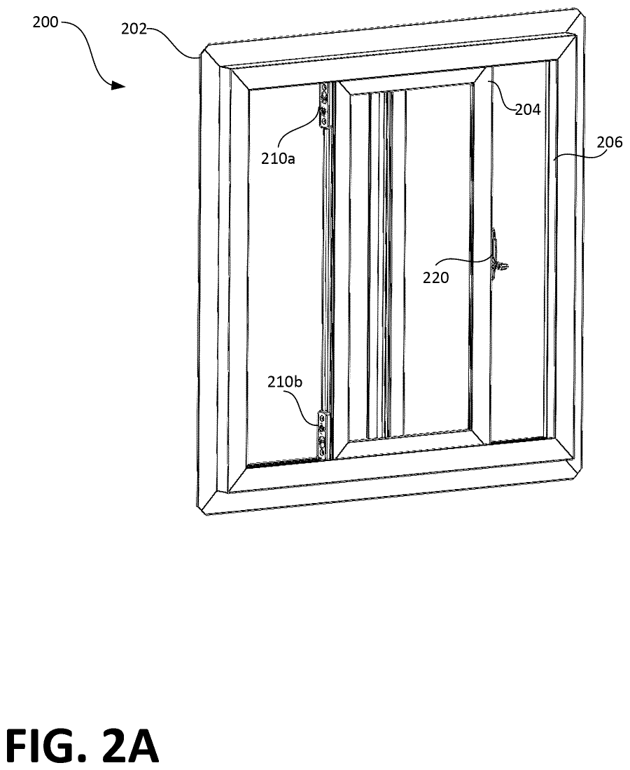

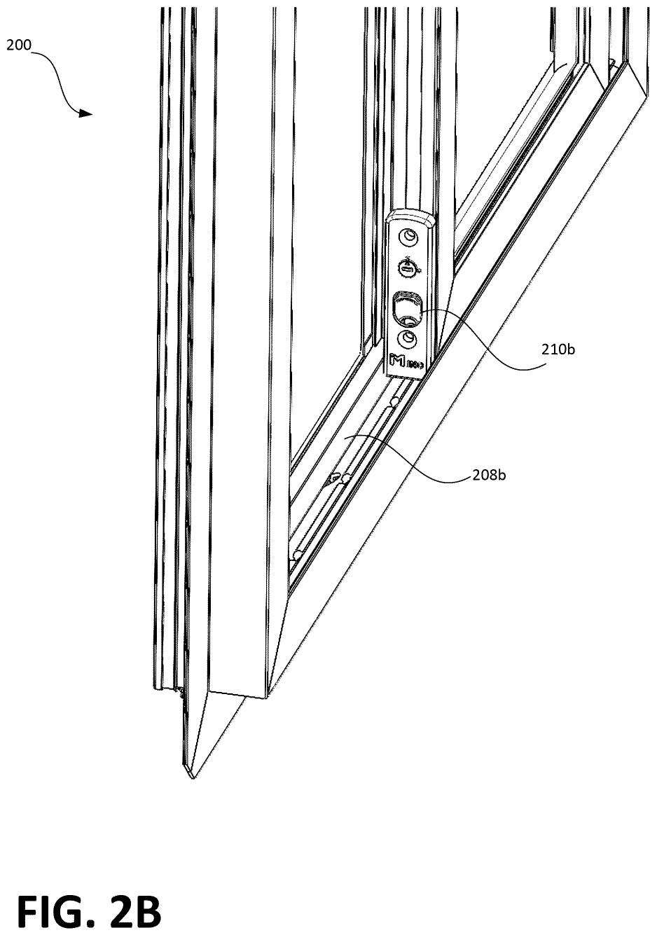

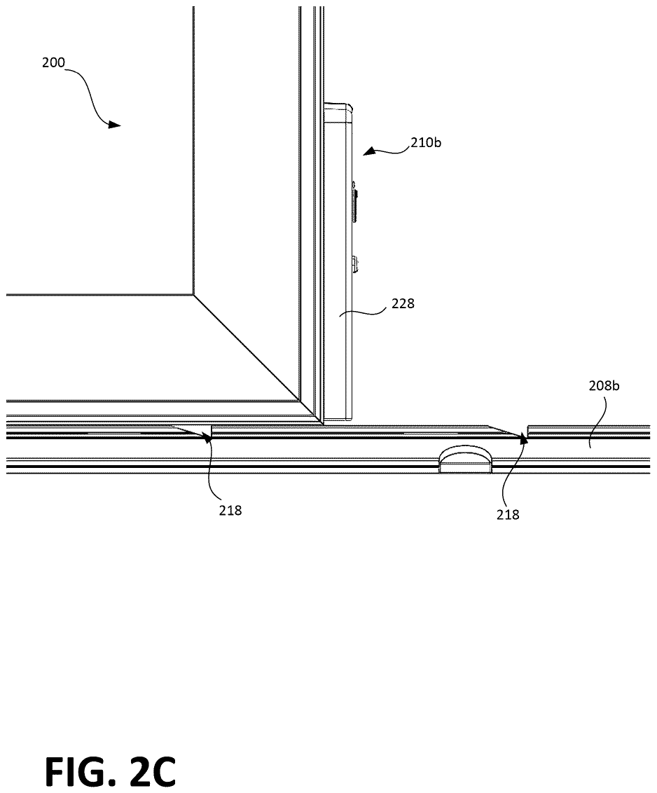

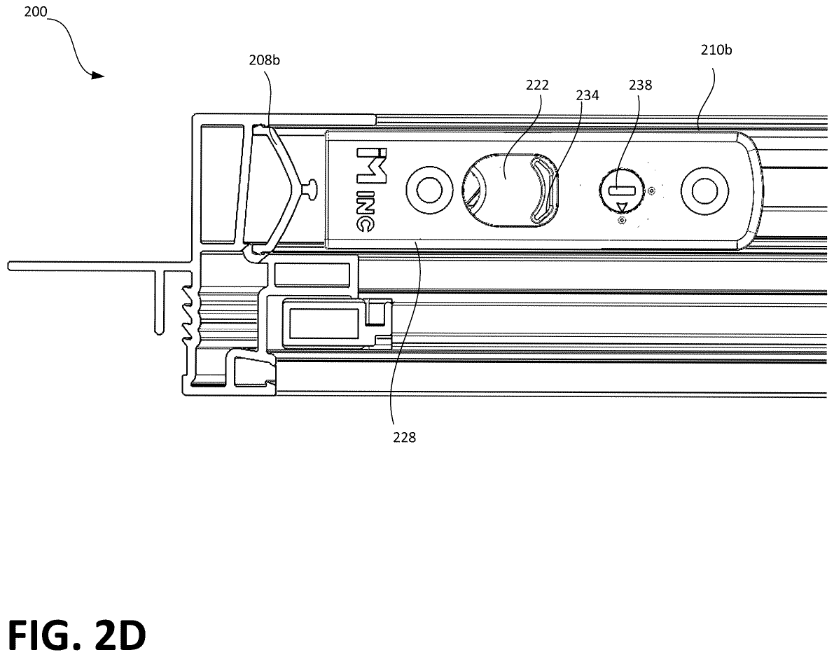

FIG. 1A depicts a perspective view of a convertible window assembly 100 in a vertical orientation, according to some embodiments of the present technology. As will be made apparent by the following disclosure, the convertible window assembly 100 may include one or more switches (e.g., switches 110a-b) that may enable the convertible window assembly 100 to selectively operate as a hung window in a vertical orientation (shown and discussed in connection with FIGS. 1A-J), and as a horizontal slider window in a horizontal orientation (shown and discussed in connection with FIGS. 2A-D).

As used herein, a vertical orientation generally refers to an orientation of the convertible window assembly 100 where the sliding direction of a slidable sash (e.g., slidable sash 104) within the frame 102 includes a vector component in the vertical direction. Similarly, a horizontal orientation as used herein generally refers to an orientation of the convertible window assembly 100 where the sliding direction of a slidable sash (e.g., slidable sash 104) within the frame 102 includes a vector component in the horizontal direction. It should therefore be appreciated that the vertical orientation is not limited to a strictly perpendicular alignment relative to the ground (e.g., 90 degrees relative to the plane of the ground), and the horizontal orientation is not limited to a strictly parallel alignment relative to the ground (e.g., 0 degrees relative to the plane of the ground). Angled or inclined orientations may also be within the scope of the present technology (e.g., from approximately 45 degrees to 135 degrees relative to the plane of the ground), provided the orientation enables motion along a path that includes a vector component in the respective horizontal or vertical direction. Such variations may accommodate architectural or structural constraints while maintaining the functional characteristics of the respective horizontal or vertical sliding.

The convertible window assembly 100 may include a frame 102, one or more slidable sashes (e.g., slidable sash 104), one or more guides (e.g., guide 108a), and one or more switches (e.g., switches 110a-b), and/or one or more fixed sashes (e.g., fixed sash 106). For example, as shown in FIG. 1A, the convertible window assembly 100 may include two sashes configured to operate as single-hung window in the vertical orientation: slidable sash 104, which is slidably positioned within the frame 102, and fixed sash 106, which is fixably mounted within the frame 102. However, it should be appreciated that the number of slidable and/or fixed sashes positioned within the frame may depend on the desired sliding window configuration in the vertical orientation, and may be modified for other configurations, including but not limited to double-hung windows and triple-hung windows which include more than one sliding sash. Thus, in some embodiments, both sash 104 and sash 106 may be slidable sashes, and in other embodiments, the convertible window assembly 100 may include two or more slidable sashes with one or more optional fixed sashes.

Multiple sashes (e.g., slidable sash 104 and fixed sash 106) may be arranged within the frame 102 in a stacked configuration, with each sash offset and positioned in a separate plane to allow relative movement between the sashes. For example, as shown in FIG. 1A, slidable sash 104 and fixed sash 106 are offset within the frame 102 such that slidable sash 104 is positioned within a plane proximate a structure interior (e.g., a shed interior), while fixed sash 106 is positioned within a plane proximate a structure exterior (e.g., a shed exterior). This arrangement may ensure that slidable sash 104 can move past or overlap fixed sash 106 without interference, while also allowing a user to slide the slidable sash 104 vertically from within the structure. However, it should be appreciated that other arrangements may be used depending on the desired sliding window configuration, and such arrangements are also within the scope of the present technology. For example, the fixed sash 106 may be positioned within the plane proximate the structure interior, while the slidable sash 104 is positioned within the plane proximate the structure exterior.

The frame 102 may be any suitable type of window frame for sliding windows, including but not limited to vinyl frames, aluminum frames, wooden frames, composite frames, fiberglass frames, steel frames, clad frames, or other suitable frames. The frame 102 may include a plurality of frame members (e.g., frame members 112a-d) that are interconnected to define an opening 114 for receiving one or more sashes (e.g., slidable sash 104 and fixed sash 106). The number, size, and arrangement of frame members 112a-d may depend on the desired shape of the frame 102, which may include standard window shapes such as rectangles and squares, as well as non-standard shapes such as arches, circles, trapezoids, or custom configurations. For example, as shown in FIG. 1A, the frame 102 includes four frame members 112a-d that are interconnected to form a conventional square-shaped frame 102 with a square-shaped opening 114. The square-shaped opening 114 may allow slidable sash 104 and fixed sash 106, both of which are rectangular-shaped, to be positioned within the opening 114 of the frame 102 such that slidable sash 104 and fixed sash 106 maintain proper coverage of the opening 114 when the window is closed.

One or more of the frame members (e.g., one or more of the frame members 112a-d) may include a recess on an inner surface of the frame member to accommodate insertion of one or more components, such as the one or more slidable sashes (e.g., slidable sash 104), the one or more guides (e.g., guide 108a), and/or one or more fixed sashes (e.g., fixed sash 106). For example, as shown in FIG. 1B, the frame member 112a includes a recess on an inner surface of the frame member 112a to accommodate the insertion of the guide 108a and the slidable sash 104. However, it should be appreciated that the frame members 112a-d are merely intended to illustrate one example of a frame 102. The frame members 112a-d may be configured in a variety of different ways depending on factors such as the type and size of the frame 102.

The edges of the one or more slidable sashes (e.g., slidable sash 104) that slide within the recess of the one or more frame members (e.g., one or more of the frame members 112a-d) may be configured to ensure smooth operation, proper alignment, and/or a secure fit. For example, such edges of the one or more slidable sashes may have a smooth, low-friction planar surface that allows the one or more slidable sashes to slide along the one or more respective guides (e.g., guide 108a). Alternatively, such edges may include a continuous channel having smooth, low-friction inner surfaces, which may allow the one or more slidable sashes to receive and slide along a protrusion (e.g., protruding member 116) of the one or more respective guides and/or the frame 102.

The size of the frame 102, and thus the size of the plurality of frame members (e.g., frame members 112a-d), may vary depending on factors such as the number and dimensions of the sashes, the intended range of movement of the slidable sashes, and/or architectural or structural requirements. For multiple sashes, a dimension of the frame 102 extending along the sliding direction of the convertible window assembly 100 (e.g., a height) may be greater than the corresponding dimension for the sashes combined (e.g., a combined height of all the sashes). This may allow for proper sliding functionality and overlap between the sashes for sealing and weatherproofing. The dimension of the frame 102 perpendicular to the sliding direction (e.g., a width) may be sized to accommodate the corresponding dimension of the sash and ensure proper engagement with the one or more guides. This may allow for proper alignment and a secure fit of the sashes within the frame 102.

For example, in some embodiments, the frame 102 may have a length of between about 12 inches and about 72 inches, including but not limited to between about 15 and about 55 inches, between about 20 and about 50 inches, between about 25 and about 45 inches, and between about 30 and about 40 inches. The frame 102 may have a width of between about 12 inches and about 72 inches, including but not limited to between about 15 and about 55 inches, between about 20 and about 50 inches, between about 25 and about 45 inches, and between about 30 and about 40 inches. The frame 102 may have a depth of between about 0.5 inches and about 4 inches, including but not limited to between about 1 inch and about 3.75 inches, between about 1.25 and about 3.5 inches, between about 1.5 and about 3 inches, and between about 2 and about 2.5 inches. Nevertheless, it should be appreciated that the dimensions for the frame 102 may vary significantly depending on the structure, and other dimensions of the frame 102 are also within the scope of the present technology.

In some embodiments, the convertible window assembly 100 may include one or more locking mechanisms 120 for securing the position of the slidable sash 104 in a closed position (e.g., shown in FIG. 1F). Each locking mechanism 120 may be any suitable type of locking mechanism, including but not limited to a latch lock (e.g., a cam lock as shown in FIG. 1A), a keyed lock, a bar lock, or other suitable lock. The locking mechanism 120 may be coupled anywhere within the convertible window assembly 100, including but not limited to the slidable sash 104 (shown in FIG. 1A), the frame 102, or other suitable location.

Further, in some embodiments, the frame 102 may include a mounting flange 140 that may be used to secure the convertible window assembly 100 to a structure (e.g., a shed) during installation. The mounting flange 140 may extend laterally outward from the frame 102, and may extend partially or entirely around the entire perimeter of the frame 102. For example, as shown in FIG. 1A, the mounting flange 140 extends laterally outward from the frame 102 and extends around the entire perimeter of the frame 102, which may facilitate installation of the convertible window assembly 100 to the structure. This may allow the convertible window assembly 100 to be placed into an opening of the structure with the mounting flange 140 overlapping with an exterior surface of the structure (e.g., an exterior sheathing, trim, and/or siding of a shed exterior wall). One or more fastening elements (e.g., fasteners, adhesives) may then be used to secure the mounting flange 140, and thus the convertible window assembly 100, to the exterior surface of the structure.

Further, in some embodiments, the frame 102 may include one or more drainage holes (not shown) to facilitate the removal of water and prevent accumulation within the frame 102. The drainage holes may be any shape, such as circular, oval, rectangular, or irregular, and may vary in size depending on the specific requirements of the design of the frame 102. The drainage holes may be located on any portion of the frame 102 (and thus frame members 112a-d), including the top, bottom, side, inner, or outer surfaces, and may be distributed symmetrically or asymmetrically to optimize drainage efficiency.

In some embodiments, the drainage holes may be positioned proximate adjacent ends of the plurality of frame members 112a-d, such that one or more drainage holes are positioned at each adjacent end of the plurality of frame members 112a-d. Further, in some embodiments, drainage holes may be positioned proximate at least two adjacent ends of the plurality of frame members 112a-d such that at least one drainage hole will be at the bottom of the convertible window assembly 100 regardless of whether the convertible window assembly 100 is in a horizontal or vertical orientation. This may facilitate the removal of water and prevent accumulation within the frame 102 regardless of its orientation. For example, in the embodiment shown in FIG. 1A, a first drainage hole (or first set of drainage holes) may be positioned proximate adjacent ends of frame members 112a and 112d, a second drainage hole (or a second set of drainage holes) may be positioned proximate adjacent ends of frame members 112d and 112b, and a third drainage hole (or a third set of drainage holes) may be positioned proximate adjacent ends of frame members 112b and 112c. Thus, in the vertical orientation shown in FIG. 1A, the first drainage hole and second drainage hole (or sets thereof) may be at the bottom of the convertible window assembly 100, and may facilitate the removal of water and prevent accumulation within the frame 102. When the convertible window assembly 100 is in a horizontal orientation (e.g., shown in FIG. 2A), the second drainage hole and the third drainage hole (or sets thereof) may be at the bottom of the convertible window assembly 100, and may facilitate the removal of water and prevent accumulation within the frame 102. Nevertheless, as previously explained, the positioning, shape, and/or number of drainage holes may be configured in a variety of different ways depending on the desired functionality of the convertible window assembly 100, and such variations are also within the scope of the present technology.

Further, in some embodiments, the convertible window assembly 100 may include one or more handles (e.g., handle 142) for raising and/or lowering the slidable sash 104 within the frame 102. For example, the slidable sash 104 may include one or more handles (e.g., handle 142) coupled to or integral with a portion of the slidable sash 104. For example, each handle may extend along all or part of the respective side (e.g., height and/or width) of the slidable sash 104. Each handle may protrude from a face of the slidable sash 104 to provide a user with an easily graspable surface to adjust the position of the slidable sash 104 within the frame 102. While FIG. 1A depicts a single handle 142 positioned on a bottom member of the slidable sash 104, it should be appreciated that the handle 142 may be positioned on other portions of the slidable sash 104, including the top and/or side members of the slidable sash 104, and the convertible window assembly 100 may include more than one handle 142.

The convertible window assembly 100 may include one or more switches (e.g., switches 110a-b) that may enable selective operation of the convertible window assembly 100 as a hung window in a vertical orientation (shown in FIGS. 1A-J), and as a horizontal slider window when the frame is in a horizontal orientation (shown in FIGS. 2A-D). As will be explained in more detail, the one or more switches (e.g., switches 110a-b) may be switchable between an engaged position and a disengaged position. Thus, for example, when the convertible window assembly is in a vertical orientation, the one or more switches (e.g., switches 110a-b) may be selectively switched to an engaged position, which may enable the convertible window assembly 100 may operate as a hung window in the vertical orientation as will be discussed in greater detail below. Similarly, when the convertible window assembly is in a horizontal orientation, the one or more switches (e.g., switches 110a-b) may be selectively switched to a disengaged position, or removed or omitted from the window assembly, which may enable the convertible window assembly 100 to operate as a horizontal slider window when the frame is in the horizontal orientation.

The particular number of switches included in the convertible window assembly 100 may vary and may correspond to the number of guides included within the convertible window assembly 100. For example, as shown in FIG. 1A, the convertible window assembly 100 may include a pair of switches 110a-b corresponding to the pair of guides (i.e., guide 108a and complementary second guide (not shown)), with switch 110a corresponding to guide 108a and switch 110b corresponding to the complementary second guide. The switches 110a-b and the pair of guides may be configured to be complementary and/or arranged symmetrically about a centerline of the frame 102 that extends in the sliding direction (e.g., a vertical centerline of the frame 102 when the frame 102 is in the vertical orientation). This may facilitate a smooth and balanced sliding operation. However, other numbers of switches and guides may be used and are also within the scope of the present technology.

The switches 110a-b may be arranged anywhere within the convertible window assembly 100 to enable interaction with a respective guide. For example, as shown in FIG. 1A, the switches 110a-b are removably coupled to a lower surface of the slidable sash 104 such that switch 110a is proximate frame member 112a (and thus, guide 108a), while switch 110b is proximate frame member 112b (and thus, the complementary second guide (not shown)). However, it should be appreciated that one or more of the switches 110a-b may be arranged in other locations, and/or may be coupled to the frame 102, the fixed sash 106, or other suitable location. Additionally, the one or more switches 110a-b may be coupled to or integral with the slidable sash 104, the frame 102, the fixed sash 106, or other component of the convertible window assembly 100.

For example, while the switches 110a-b shown in FIGS. 1A-2D are removably coupled to a lower surface of the slidable sash 104, it should be appreciated that the switches 110a-b may be coupled to or integral with any portion of the frame 102, and/or the respective guides (e.g., guide 108a) may be coupled to or integral with the slidable sash 104. For instance, as shown in FIG. 1B, the frame member 112a has a recess on an inner surface of the frame member 112a, the guide 108a is removably coupled with a base surface of the recess, and the switch 110a is removably coupled to a lower surface of the slidable sash 104. However, in some embodiments, the switch 110a may be coupled to or integral with a portion of the frame 102, such as an outer surface of the frame member 112a, or the switch 110a may be coupled to or integral with an inner surface of the recess, in which case the switch 110a may at least partially protrude through the frame member 112a. In such embodiments, the guide 108a may be coupled to and/or integral with an edge of the slidable sash 104 that slides within the recess of the frame members 112a.

Further, in such embodiments, the switch 110a may include a user-actuation feature, such as a button, remote controller, or other user-actuation feature discussed herein, that may enable a user selectively switch the switch 110a between the engaged position and the disengaged position. For example, the switch 110a in FIG. 1B may be positioned on an outer surface of the frame member 112a that faces the structure interior (e.g., a shed interior), which may provide a user with easy access to the switch 110a. The switch 110a may include a button that may be actuated by the user, thus allowing the user to selectively switch the switch 110a between the engaged position and the disengaged position depending on the desired orientation of the convertible window assembly 100.

The frame 102, slidable sash 104, guide 108a, switches 110a-b, fixed sash 106, and other components of the convertible window assembly may be constructed from a wide range of materials to accommodate various design preferences, performance requirements, and/or environmental conditions. For example, such materials may include metals such as aluminum, steel, or other alloys; polymers such as PVC, fiberglass, or composite plastics; natural materials such as wood; other suitable materials; and/or combinations thereof.

FIG. 1B depicts a detail view of a switch 110a and a guide 108a of the convertible window assembly 100 of FIG. 1A, according to some embodiments of the present technology. As will be made apparent by the following disclosure, with the convertible window assembly 100 in the vertical orientation shown in FIGS. 1A-B, the switch 110a may be selectively switched to the engaged position, which may enable the convertible window assembly 100 to operate as a hung window. Further, while FIG. 1B-E only show switch 110a and guide 108a, it should be appreciated that the following description may also apply to switch 110b and the corresponding guide (not shown) on an opposing side of the frame 102, or any other switch and corresponding guide of the convertible window assembly 100.

The switch 110a being in the engaged position may enable an engagement member 122 of the switch 110a to contact and/or otherwise interact with the guide 108a as the slidable sash 104 is raised vertically along the guide 108a. For example, when the engagement member 122 switch 110a is inserted within and/or otherwise engages with a first engagement feature (e.g., a lower notch 118) of the guide 108a, downward sliding movement of the slidable sash 104 may be restricted while upward sliding movement of the slidable sash 104 may be unrestricted. This may allow the slidable sash 104 to remain at a first vertical sliding position (e.g., shown in FIG. 1E), and/or be further raised until the switch 110a engages with a second engagement feature (e.g., an upper notch 118), which allows the slidable sash 104 to remain at a second more elevated sliding position (e.g., as shown in FIG. 1F). In the vertical orientation, the restriction of downward sliding movement of the slidable sash 104 may prevent the slidable sash 104 from accidentally slamming shut, which could pose safety risks such as pinched fingers, and/or may damage the frame 102, the slidable sash 104, and/or any objects beneath the convertible window assembly 100.

One or more guides (e.g., guide 108a) may be disposed along all or a portion of a length of the frame 102 (in one or more segments) for guiding slidable movement of the one or more slidable sashes (e.g., slidable sash 104), thus facilitating a smooth and controlled sliding operation. The one or more guides (e.g., guide 108a) may be removably coupled to or integral with the frame 102. The particular number and arrangement of guides included in the convertible window assembly 100 may vary depending on the design of the frame 102. For example, the convertible window assembly 100 may include a pair of guides disposed along respective lengths of opposing frame members (e.g., frame members 112a-b), which may facilitate slidable movement of the slidable sash 104 within the frame 102. In such embodiments, the pair of guides may be configured to be complementary and/or substantially symmetric about a centerline of the frame 102 that extends in the sliding direction, and/or the pair of guides may be disposed along substantially equivalent lengths of the opposing frame members (e.g., frame members 112a-b) to facilitate a balanced sliding operation. Thus, as shown in FIGS. 1A-B, the frame member 112a may include the guide 108a with protruding member 116 and notches 118, and the opposing frame member 112b may include a second guide (not shown) having a complementary protrusion member and notches that are substantially symmetric about a centerline of the frame 102 that extends in the sliding direction. This may allow switch 110a and switch 110b to simultaneously engage with the notches of the respective guide 108a and the second guide (not shown). However, it should be appreciated that only one guide (e.g., guide 108a) or more than two guides may be used for other configurations, including but not limited to double-hung windows and triple-hung windows with more than one sliding sash, and/or the guides may be configured in different arrangements within the frame 102.

The one or more guides may include any suitable shape, which may depend on factors such as the size and shape of the frame 102 and/or whether the one or more guides are removable coupled to or integral with the frame 102. For example, the one or more guides may have an elongate shape with a square cross-section, a rectangular cross-section, a circular cross-section, a triangular cross-section, an irregular cross-section, or other suitable cross-section. As shown in FIG. 1J, the guide 108a has a V-shaped cross-section with one or more snap-fit features (e.g., a protrusion) located at terminal ends of the guide 108 for engaging with corresponding snap-fit features (e.g., a groove) of the frame member 112a. Such features may facilitate a removable coupling of the guide 108 and the frame 102. However, it should be appreciated that the guide 108a shown is merely intended to illustrate one example, and the guide 108 may be configured in a variety of different ways depending on factors such as the size and shape of the frame 102 and/or whether the one or more guides are removable coupled to or integral with the frame 102.

The length of each guide (e.g., guide 108a) may vary depending on the intended range of slidable movement of the slidable sash (e.g., slidable sash 104). Thus, for example, as shown in FIGS. 1A-B, the guide 108a extends along a full length of an inner surface of frame member 112a, which may enable the slidable sash 104 to slide along the full range of slidable movement within the frame 102. However, the one or more guides (e.g., guide 108a) may only extend along a portion of the inner surface of one or more of the frame members. This may be suitable, for example, when a smaller sliding length is desired, and/or in double-hung windows or triple-hung windows with multiple overlapping or staggered sliding sashes. For example, the guide 108a may extend from about 20% to about 100% of the length of the inner surface of frame member 112a, which may include but is not limited to from about 20% to about 50% of the length of the inner surface of frame member 112a, from about 40% to about 70% of the length of the inner surface of frame member 112a, from about 60% to about 90% of the length of the inner surface of frame member 112a, or from about 80% to about 100% of the length of the inner surface of frame member 112a.

The one or more guides (e.g., guide 108a) may include one or more protruding members (e.g., protruding member 116) for engaging with a respective side portion of a slidable sash (e.g., slidable sash 104). The protruding member 116 may protrude laterally outward from the guide 108a, and the guide 108a may be arranged within the frame 102 such that the protruding member 116 extends inward relative to the frame 102 for engaging with a respective side portion of the slidable sash 104. The protruding member 116 may comprise any feature for engaging with a respective side portion of a slidable sash (e.g., slidable sash 104), including but not limited to a track, a channel, a rail, or other suitable feature. For example, as shown in FIGS. 1B-C, the protruding member 116 may include a T-shaped protrusion for engaging with a respective side portion of the slidable sash 104. However, it is also contemplated and within the scope of the present technology that the slidable sash 104 may include the protruding member 116, which may protrude laterally outward from the slidable sash 104 for engaging with the guide 108a.

The protruding member 116 may extend along a full length of the guide 108a or along a portion of the length of the guide 108a. For example, the protruding member 116 may extend from about 20% to about 100% of the length of the guide 108a, which may include but is not limited to from about 30% to about 90% of the length of the guide 108a, from about 40% to about 80% of the length of the guide 108a, from about 50% to about 70% of the length of the guide 108a, or from about 55% to about 65% of the length of the guide 108a. Additionally, the protruding member 116 may extend from about 5% to about 50% of the thickness of the guide 108a, which may include but is not limited to from about 10% to about 45% of the thickness of the guide 108a, from about 15% to about 40% of the thickness of the guide 108a, from about 20% to about 35% of the thickness of the guide 108a, or from about 25% to about 30% of the thickness of the guide 108a.

The protruding member 116 may include a plurality of engagement features (e.g., notches 118) configured to interact with a corresponding switch (e.g., switch 110a) when the corresponding switch is in the engaged position. The plurality of engagement features may be any feature for interacting with a corresponding feature of the switch, including but not limited to recessed features (e.g., notches, slots, holes, detents, pockets, channels, depressions) and/or protruding features (e.g., tabs, ribs, teeth, projections). For example, as shown in FIG. 1B, the protruding member 116 includes a plurality of notches 118 for interacting with an engagement member 122 (shown in FIG. 1C) of the switch 110a.

The plurality of engagement features (e.g., notches 118) may be spaced along at least a portion of the length of the frame 102 such that each engagement feature corresponds to a respective vertical sliding position of the slidable sash 104. Thus, for example, a lower notch 118 may correspond to a lower vertical position of the slidable sash 104 within the frame 102 (e.g., as shown FIG. 1G), while an upper notch 118 may correspond to an upper vertical position of the slidable sash 104 within the frame 102 (e.g., as shown in FIG. 1H). It should therefore be appreciated that the particular number and spacing (e.g., at regular and/or irregular intervals) of the plurality of engagement features may depend on a variety of factors, such as the desired number of adjustment sliding positions of the slidable sash 104 and/or the dimension(s) of the frame 102. For example, the protruding member 116 may include at least one engagement feature, at least two engagement features, at least three engagement features, at least four engagement features, at least five engagement features, or other suitable number of engagement features.

One or more of the engagement features (e.g., notches 118) may be positioned, shaped, and/or otherwise configured to improve the safety of the convertible window assembly 100. For example, one or more lowermost notches 118 of the one or more respective guides (e.g., guide 108a) may be positioned proximate the lowermost frame member (e.g., frame member 112d) when the convertible window assembly 100 is in the vertical orientation. This may allow the lowermost notches 118 to act as safety stops that hold the slidable sash 104 slightly above the fully closed position, thereby creating a small gap between the lowermost frame member 112d and the slidable sash 104. This may prevent a user's finger's from being crushed or pinched when the slidable sash 104 is being lowered within the frame 102.

Additionally, as explained earlier, the one or more guides (e.g., guide 108a), and thus the plurality of engagement features (e.g., notches 118) may be integral with the frame 102. Thus, while FIG. 1B shows frame member 112a having a U-shaped recess on an inner surface of the frame member 112a, and the guide 108a (and thus the notches 118) being removably coupled with a base surface of the U-shaped recess, it should be appreciated that the notches 118 may be integral with the frame member 112a, and/or the notches 118 may be positioned at other locations of the frame member 112a, such as the sidewalls of the U-shaped recess of the frame member 112a.

FIGS. 1C-E depict detail views of the switch 110a interacting with the guide 108a at different sliding positions of the convertible window assembly 100 of FIG. 1A, according to some embodiments of the present technology. FIGS. 1F-I depict different sliding positions of the convertible window assembly 100 of FIG. 1A, according to some embodiments of the present technology. The one or more switches (e.g., switch 110a) may include an engagement member 122 that is movable between an engaged position (shown in FIGS. 1C-E) and a disengaged position (shown in FIGS. 2C-D). As shown in FIGS. 1C-E, when the engagement member 122 is in the engaged position, the engagement member 122 protrudes laterally outward relative to the switch housing 128 and contacts the guide 108a. This may allow the engagement member 122 to interact with walls of the protruding member 116 that define one or more of the notches 118, which may restrict slidable movement of the slidable sash 104 in least one direction along the length of the frame 102. Additionally, the engagement member 122 may be biased to interact with the guide 108a. For example, as shown in FIGS. 1C-E, the engagement member 122 is spring-loaded such that the engagement member 122 is biased to project outwardly and contact the guide 108a. Thus, as will be explained in more detail, the spring-loaded engagement member 122 may remain in contact with the guide 108a as the slidable sash is raised upwardly within the frame, and the engagement member 122 may be selectively actuated inward to create a gap between the engagement member 122 and the guide 108a, which may allow the slidable sash 104 to be lowered within the frame. However, other biasing methods may also be utilized and are within the scope of the present disclosure, including but not limited to magnets, non-spring elastic components (e.g., elastic cords), actuators, or other suitable biasing methods.

The plurality of engagement features (e.g., notches 118) may be configured to restrict movement of a slidable sash (e.g., slidable sash 104) in at least one direction along the length of the frame 102. For example, as shown in FIGS. 1C-E, each of the notches 118 may include a planar surface 124 extending laterally relative to the guide 108a and an angled surface 126 extending from the planar surface 124 in a longitudinal direction relative to the guide 108a. The angled surface 126 may connect the planar surface 124 with the upper surface 130 of the protruding member 116. The angled surface 126 may therefore extend upward from the planar surface 124 and inward towards the slidable sash 104 to form a ramp-like structure. Thus, as the spring-loaded engagement member 122 is raised upwardly along the guide 108 (e.g., shown in FIG. 1D), the engagement member 122 remains in contact with the upper surface 130 of the protruding member 116 until the engagement member 122 engages with a notch 118. When the engagement member 122 engages with a notch 118 (e.g., shown in FIG. 1E), the spring-loaded engagement member 122 may extend into the void created by the notch 118 due to the spring force, and the flat, horizontal, or otherwise planar nature of the planar surface 124 may allow a portion of the engagement member 122 to rest on the planar surface 124 due to gravitational forces acting on the slidable sash 104. This may prevent the engagement member 122 from moving downward, effectively locking it in place in that direction. However, the ramp-like structure created by the angled surface 126 may allow for upward movement of the engagement member 122. As the engagement member 122 moves up from the planar surface 124 and along the angled surface 126, interaction between the engagement member 122 and the angled surface 126 causes the engagement member 122 to compress or retract inward, allowing it to glide smoothly out of the notch 118 and transition back into contact with the upper surface 130 of the protruding member 116. This may allow the slidable sash 104 to be raised within the frame without needing to manually adjust the switch 110a. Nevertheless, it should be appreciated that the particular engagement features shown (i.e., notches 118) are merely intended to illustrate one example. As previously explained, the engagement features may be reconfigured in a variety of different ways, and slidable movement of the slidable sash 104 may therefore be restricted in a different direction or in multiple directions as desired.

Interaction between the engagement member 122 and the guide 108a (including the engagement features) may allow the convertible window assembly 100 to function as a hung window in a vertical orientation. For example, the slidable sash 104 may be raised from a fully closed position (shown in FIG. 1F) until the engagement member 122 engages with a first notch 118, thereby limiting downward movement of the slidable sash 104 and securing the slidable sash 104 in a first position (shown in FIGS. 1C and 1G). Because the engagement member 122 is spring loaded, the engagement member 122 may protrude laterally outward relative to the switch housing 128 and project into the recessed void formed by the notch 118. Due to gravitational forces acting on the slidable sash 104, the engagement member 122 may rest on the planar surface 124 of the notch 118, which in turn limits downward movement of the slidable sash 104 while upward movement of the slidable sash 104 remains unrestricted. The slidable sash 104 may be further raised from the first position until the engagement member 122 engages with a second notch 118 and secures the slidable sash 104 in a second more elevated position (shown in FIGS. 1E and 1H). FIG. 1D shows the slidable sash 104 at an intermediate position, i.e., a position of the slidable sash 104 within the frame 102 where the engagement member 122 is above and/or below or more notches 118. Because the engagement member 122 is spring-loaded, the engagement member 122 may remain in contact with the upper surface 130 of the protruding member 116 in an intermediate position. When the slidable sash 104 is in an intermediate position, the engagement member 122 remains partially retracted within the switch housing 128, until the slidable sash 104 is raised to a position which the engagement member 122 engages with a notch 118 and projects outward into the recessed void formed by the notch 118. The slidable sash 104 may be raised within the frame 102 until the engagement member 122 engages with a notch 118 corresponding to a desired height and/or until the engagement member 122 engages with an upper most notch 118 and secures the slidable sash in a third, fully open position (shown in FIG. 1I).

FIG. 1J depicts a bottom view of the switch 110a and the guide 108a of the convertible window assembly of FIG. 1B, according to some embodiments of the present technology. As shown, the switch 110a is in the engaged position, which may enable the engagement member 122 to contact the guide 108a and interact with the notches 118 as the slidable sash 104 is raised and lowered within the frame 102. As previously explained, this may allow the convertible window assembly 100 to operate as a hung window in the vertical orientation. Moreover, as will be discussed in more detail, the switch 110a may also be selectively switched to a disengaged position (shown in FIG. 2C), which may remove engagement and/or contact between the engagement member 122 and the guide 108a, thereby enabling unrestricted slidable movement of the slidable sash 104 within the frame 102. Therefore, when the convertible window assembly 100 is in the vertical orientation, the disengaged position of the switch 110a may allow slidable sash 104 to be lowered within the frame 102; and when the convertible window assembly 100 is in the horizontal orientation, the disengaged position of the switch 110a (or its removal or omission from the convertible window assembly 100) may enable the convertible window assembly 100 to operate as a horizontal slider window.

The switch 110a may include an engagement member 122 that is movably positioned within the switch housing 128, with the engagement member 122 being movable between the engaged position (shown in FIG. 1J) in which the distal end of the engagement member 122 protrudes beyond the switch housing 128 and the lateral edge of the slidable sash 104 and may interact with the guide 108 and the disengaged position (shown in FIG. 2C) in which the distal end of the engagement member 122 is retracted relative to the guide 108. The engagement member 122 may be any suitable shape and size for engaging with the plurality of engagement members (e.g., notches 118). For example, as shown in FIG. 1J, the engagement member 122 has an elongate generally rectangular shape with a tab portion 132 configured to engage with the upper surface 130 of the protruding member 116 and the notches 118. This may facilitate the projection and retraction of the engagement member 122 relative to the switch housing. Additionally, as shown in FIGS. 1C-1E, the tab portion 132 may be tapered to correspond to the shape of the notches 118 (e.g., the planar surface 124 and the angled surface 126), thereby facilitating the engagement with the notches 118. The size and dimensions of the engagement member 122 may vary depending on the size of the plurality of engagement features, the size of the switch housing 128, and/or the location of the switch 110a relative to the guide 108a. Thus, for example, as shown in FIG. 1J the engagement member 122 may have a length sufficient to protrude outwardly from the switch housing 128 and contact the guide 108a when the switch 110a is in the engaged position, and retract within and/or otherwise toward the switch housing 128 to create a sufficient gap between the engagement member 122 and the guide 108a when the switch 110a is in the disengaged position.

The switch 110a may include a switch housing 128, which may contain the engagement member 122. As previously explained, the switch 110a (and thus the switch housing 128) may be arranged anywhere within the convertible window assembly 100 to enable interaction with a respective guide (e.g., guide 108a). For example, as shown in FIG. 1J, the switch housing 128 is removably coupled to a lower surface of the slidable sash 104 such that switch 110a is proximate frame member 112a (and thus, guide 108a). Such positioning may provide certain benefits, such as improved access to the switch 110 when a user raises the slidable sash 104. The switch housing 128 may be removably coupled to the slidable sash 104 (or other component of the convertible window assembly 100) using any suitable coupling method, including but not limited to mechanical fasteners, adhesives, interlocking parts, and/or other suitable coupling methods. For example, as shown in FIG. 1J, the switch housing 128 may include one or more apertures 136 for receiving a mechanical fastener (e.g., a threaded screw). The engagement member 122 may include one or more corresponding elongate slots (not shown), which may allow the fastener to be inserted therethrough while allowing the engagement member 122 to move between the engaged position and the disengaged position. The slidable sash 104 may also include one or more corresponding apertures for receiving the fastener, such as a threaded hole for engaging with a threaded screw, which may secure the switch 110a to the slidable sash 104. Additionally, as explained earlier, the switch housing 128 may be integral with the slidable sash 104 (or other component of the convertible window assembly 100). This may provide certain benefits, such as a reduction in the overall number of parts in the convertible window assembly 100.

To lower the slidable sash 104 in the vertical orientation from an elevated position (e.g., as shown in FIGS. 1H and 1E) to a lower position (e.g., as shown in FIGS. 1G and 1D), the switch 110a may be selectively switched from the engaged position (shown in FIG. 1J) to the disengaged position (shown in FIG. 2C). In the disengaged position, engagement and/or contact between the engagement member 122 and the guide 108a is removed, thereby enabling unrestricted slidable movement of the slidable sash 104 within the frame 102. For example, as explained earlier, in the disengaged position, the engagement member 122 may retract within the switch housing 128 to create a sufficient gap between the engagement member 122 and the guide 108a. This gap may prevent the engagement member 122 from contacting and/or otherwise engaging with the engagement features (e.g., walls of the protruding member 116 that define the notches), and thus, the slidable sash 104 may be lowered within the frame 102 without restriction. Thus, the slidable sash 104 may be lowered to a desired position while the switch 110a is in the disengaged position, and the switch 110a may then be switched back to the engaged position to engage with a notch 118 associated with a lower position.

The switch 110a may include one or more user-actuated features to facilitate lowering of the slidable sash 104 in the vertical orientation from an elevated position to a lower position. For example, as shown in FIG. 1J, the engagement member 122 includes an actuation tab 134, which may allow a user to actuate the engagement member 122 from the engaged position to the disengaged position. The actuation tab 134 may extend through a slot formed in a bottom surface of the switch housing 128 and may provide an accessible interaction point for a user's finger or thumb. The actuation tab 134 shown in FIG. 1J includes a c-shaped or otherwise curved protrusion to facilitate actuation with a thumb or finger. However, it should be appreciated that the actuation tab 134 may be positioned in different locations relative to the switch 110a and may include a number of different shapes, and such variations are also within the scope of the present technology.

Because the engagement member 122 may be spring-loaded (or otherwise biased to contact the guide 108a), the inclusion of the actuation tab 134 may enable a user to actuate the engagement member 122 from the engaged position to the disengaged position by pressing on the actuation tab 134 with a finger or thumb. Thus, when actuated, a gap may be created between the engagement member 122 and the guide 108a, allowing the user to lower the slidable sash 104 until the engagement member 122 is lowered below the corresponding notch 118 of the elevated position. The user may then release the actuation tab 134, which enables the spring or other biasing force to move the engagement member 122 toward the engaged position to reestablish engagement and/or contact between the engagement member 122 and the guide 108a, allowing the user to secure the slidable sash 104 in a lower position when the engagement member 122 engages with a corresponding notch 118 of a lower position.

However, it should be appreciated that other user-actuation features may be incorporated into the switch 110a and are also within the scope of the present technology, including but not limited to mechanical actuation mechanisms (e.g., rotary knobs, sliders, push buttons, levers), electronic actuation mechanisms (e.g., switches, buttons, touchscreens, remote controllers), smart actuation mechanisms (e.g., gesture-based actuation, voice-controlled actuation), magnetic actuation mechanisms, or other suitable actuation mechanisms.

To reconfigure the convertible window assembly 100—which has been previously discussed herein as operating as a hung window in a vertical orientation—to operate as a horizontal slider window in a horizontal orientation (and vice versa), the switch 110a may include one or more features for selectively securing the switch 110a in at least one of engaged position and the disengaged position. For example, as shown in FIG. 1J, the switch 110a may include a locking feature (e.g., rotatable lock 138) to secure the engagement member 122 in the disengaged position. Thus, to secure the engagement member 122 in the disengaged position, the engagement member 122 may be retracted within the switch housing 128 by pressing on the actuation tab 134 with a finger or thumb, and the rotatable lock 138 may be rotated from an unlocked position (shown in FIG. 1J) to a locked position (shown in FIG. 2D), preventing the engagement member 122 from protruding outwardly and contacting the guide 108a. The rotatable lock 138 may be positioned at least partially within the switch housing 128, and a portion of the rotatable lock 138 (e.g., a slot or groove) may be accessible via a hole formed in the switch housing 128. This may allow a user to rotate the rotatable lock 138 via the slot, groove, or other suitable feature using a finger, fingernail, or other suitable tool.

The rotatable lock 138 may include one or more engagement features (e.g., recesses) that are configured to interact with one or more corresponding engagement features (e.g., protrusions) of the engagement member 122. For instance, rotatable lock 138 may include a protrusion (not shown) that can selectively engage with a channel or groove (not shown) formed in the engagement member 122. The protrusion of the rotatable lock 138 may be positioned such that when the rotatable lock 138 is in the unlocked position (shown in FIG. 1J), the protrusion of the rotatable lock 138 is spaced from and thus does not contact or otherwise engage with the channel or groove of the engagement member 122. This may allow the engagement member 122 to remain in the engaged position. To secure the engagement member 122 in the disengaged position, the engagement member 122 may be retracted within the switch housing 128, and the rotatable lock 138 may be rotated to the locked position (shown in FIG. 2D). When the rotatable lock 138 is rotated to the locked position (shown in FIG. 2D), the protrusion of the rotatable lock 138 may contact and engage with the channel or groove of the engagement member 122, thereby preventing the engagement member 122 from protruding outwardly.

However, it should be appreciated that the rotatable lock 138 is merely intended to illustrate one example of a locking feature, and the locking feature may be configured in a variety of different ways depending on various factors, such as the particular design of the switch 110a, the direction of bias of the switch 110a, and/or other design considerations of the convertible window assembly 100. For example, the locking feature may include but is not limited to a latch, a switch, a pin (e.g., a pin lock), a cam lock, a key (e.g., a keyed lock), a fastener, a screw (e.g., a screw lock), a bar lock, a smart lock, or other suitable locking feature.

FIG. 2A depicts a perspective view of a convertible window assembly 100 in a horizontal orientation, according to some embodiments of the present technology. The convertible window assembly 100 may be analogous to the convertible window assembly 100 of FIGS. 1A-J, and may include a frame 102, a slidable sash 104, guide 108a, switches 110a-b, a fixed sash 106, and locking mechanism 120. Unlike in the vertical orientation, the convertible window assembly 100 in the horizontal orientation may not face the same risk of gravity-induced movement of the slidable sash 104, as the slidable sash moves horizontally within the frame 102 rather than vertically. Thus, when the convertible window assembly 100 is in a horizontal orientation, the switches 110a-b may be selectively switched to a disengaged position, thereby enabling unrestricted slidable movement of the slidable sash 104 within the frame 102 and allowing a user to move the slidable sash 104 horizontally within the frame 102. Additionally or alternatively, the switches 110a-b may be removed or omitted from the slidable sash 104 (or other portion of the convertible window assembly 100), thereby enabling unrestricted slidable movement of the slidable sash 104 within the frame 102 and allowing a user to move the slidable sash 104 horizontally within the frame 102 when the convertible window assembly 100 is in a horizontal orientation.

In some embodiments, the switches 110a-b may be removably coupleable to the slidable sash 104 (or other portion of the convertible window assembly 100), which may provide improve flexibility and adaptability. For example, this may allow the switches 110a-b to be removed from the slidable sash 104 (or other portion of the convertible window assembly 100) when the convertible window assembly 100 is installed in a horizontal orientation. Alternatively, this may allow the switches 110a-b to be provided separately from other components of the convertible window assembly 100, allowing a user or installer to selectively install or not install the switches 110a-b depending on the desired orientation of the convertible window assembly 100. For instance, if a user or installer wants to install the convertible window assembly 100 in a horizontal orientation, they may choose not to install the switches 110a-b and/or discard the switches 110a-b. Alternatively, the convertible window assembly 100 may omit the switches 110a-b from the assembly for horizontal installations, and may include the switches 110a-b separately or pre-installed for vertical installations.

FIGS. 2B-D depict detail views of the switch 110b of the convertible window assembly 100 of FIG. 2A in a disengaged position, according to some embodiments of the present technology. As previously explained, the switch 110b may be selectively secured in the disengaged position, which may remove engagement and/or contact between the engagement member 122 and the guide 108b, thereby enabling unrestricted horizontal slidable movement of the slidable sash 104 within the frame 102. Further, while FIGS. 2B-D only show switch 110b and guide 108b, it should be appreciated that the following description may also apply to switch 110a and the corresponding guide (not shown) on an opposing side of the frame 102.

For example, with the convertible window assembly 100 in the horizontal orientation, the engagement member 122 may be retracted within the switch housing 128 by pressing on the actuation tab 134 with a finger or thumb. The retraction of the engagement member 122 within the switch housing 128 may form a gap between the engagement member 122 and the guide 108b. This gap may prevent the engagement member 122 from contacting and/or otherwise engaging with the engagement features (e.g., notches 118). The engagement member 122 may be secured in the disengaged position via the rotatable lock 138, which may be rotated from an unlocked position (shown in FIG. 1J) to a locked position (shown in FIG. 2D), thus maintaining the gap between the engagement member 122 and the guide 108b and allowing the slidable sash 104 to move horizontally within the frame 102. To secure the position of the slidable sash 104 in a closed position, the locking mechanism 120 may be engaged, and the locking mechanism 120 may be disengaged to allow sliding the slidable sash 104 in an open position (e.g., shown in FIGS. 2A-B). Nevertheless, it should be appreciated that the switch 110b, guide 108b, and/or other elements of the convertible window assembly 100 shown are merely intended to illustrate one example, and as previously explained, may be reconfigured in a variety of different ways to enable horizontal sliding of the slidable sash 104 within the frame 102.

The convertible window assembly 100 may include various optional features to enhance functionality, usability, and/or durability. For example, balancing mechanisms may be incorporated to ensure smooth and controlled movement of the slidable sash 104 when the convertible window assembly 100 is in the vertical orientation. Such mechanisms may be disassemblable, removable, or otherwise disengageable, such as when the convertible window assembly 100 operates in the horizontal orientation, where balancing or gravity-countering mechanisms may not be necessary. For example, such mechanisms may include disengageable spring balances, which provide adjustable tension to accommodate different sash weights or user preferences, or gravity-based balances, which rely on counterweights to stabilize the sash during operation. A spring balance system may be disassemblable or removable, or may include a releasable locking mechanism or other disengagement feature that allows the user to disengage the spring tension for maintenance or cleaning purposes, or when the convertible window assembly 100 is in a horizontal orientation. Similarly, a gravity-based balance may include a pulley and counterweight system to enable effortless sliding while maintaining the slidable sash 104 in a desired position in the vertical orientation. The pully and counterweight system may be disassemblable, removable, or otherwise disengageable such that the convertible window assembly 100 may operate in the horizontal orientation, where the risk of the slidable sash 104 falling or becoming difficult to control due to gravity is reduced. Additional optional features may include weatherstripping or sealing components to improve energy efficiency by reducing air and water infiltration, decorative finishes, ergonomic handles, noise-dampening materials, and/or other suitable features for improving the aesthetics and/functionality of the convertible window assembly 100.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

As used herein and in the following claims, the singular forms “a”, “an”, and “the” include plural references unless the context clearly dictates otherwise. Thus, for example, reference to “an element” includes a plurality of such elements, and reference to “the aperture” includes reference to one or more apertures and equivalents thereof known to those skilled in the art, and so forth.

Further, as used herein and in the following claims, the term “generally” is used to describe a characteristic, relationship, or condition that is broadly applicable or approximate, without requiring absolute precision or exact conformity unless explicitly stated. The term is intended to encompass reasonable variations or deviations while still reflecting the overall essence or intended scope of the described feature, structure, or relationship. For example, “generally” may refer to shapes, orientations, or alignments that deviate by a range of ±20% from a specified description, depending on the context and functional requirements.

Further, as used herein and in the following claims, the term “proximate” is intended to encompass both being at a particular location and being near or in close proximity to a particular location. It should therefore be appreciated that the specific meaning of “proximate” may vary depending on the context of the technology, and it is not limited to an exact location unless explicitly stated. For example, “proximate” may refer to a location within a defined range, such as within a few millimeters, centimeters, or meters in physical distance, or within a defined percentage range of a particular parameter. By way of illustration, “proximate” may include being within ±20% of a specified distance or measurement, depending on the application. Such ranges are provided as examples and should not be considered limiting unless explicitly stated. The scope of “proximate” should be understood in accordance with the principles and objectives of the technology as described herein.

Further, as used herein and in the following claims, the words “comprise(s)”, “comprising”, “contain(s)”, “containing”, “include(s)”, and “including” are intended to specify the presence of stated features, integers, components, or operations, but they do not preclude the presence or addition of one or more other features, integers, components, operations, acts, or groups.

What is claimed is:

1. A convertible window assembly, comprising:
a frame;
a sash slidably positionable within the frame;
a guide disposed along a length of the frame and configured to guide slidable movement of the sash relative to the frame; and
a switch that is removably coupleable with the sash, the switch being configured to enable selective operation of the convertible window assembly as a horizontal slider window when the frame is in a horizontal orientation, and as a hung window when the frame is in a vertical orientation.

2. The convertible window assembly of claim 1, wherein:
the guide comprises a plurality of engagement features spaced along at least a portion of the length of the frame; and
the switch comprises an engagement member movable between an engaged position and a disengaged position, wherein:
in the engaged position, the engagement member is configured to interact with at least one of the engagement features to restrict slidable movement of the sash in at least one direction along the length of the frame; and
in the disengaged position, slidable movement of the sash along the length of the frame is unrestricted.

3. The convertible window assembly of claim 2, wherein:
in the engaged position, the engagement member is configured to interact with at least one of the engagement features to restrict downward vertical sliding of the sash when the frame is in the vertical orientation.

4. The convertible window assembly of claim 2, wherein:
in the engaged position, the engagement member protrudes laterally outward relative to a body of the switch and contacts the guide.

5. The convertible window assembly of claim 2, wherein:
in the disengaged position, horizontal sliding of the sash along the length of the frame is unrestricted when the frame is in the horizontal orientation.

6. The convertible window assembly of claim 2, wherein:
the engagement member is biased to interact with the guide.

7. The convertible window assembly of claim 2, wherein:
the switch comprises a locking feature configured to selectively secure the engagement member in at least one of the engaged position and the disengaged position.

8. A convertible window assembly, comprising:
a frame comprising a plurality of frame members interconnected to define an opening;
a sash slidably positionable within the opening of the frame;
a guide disposed along at least a portion of an inner surface of at least one of the plurality of frame members, the guide comprising a protruding member having a plurality of notches spaced along a length of the guide;
a switch removably coupleable to the sash, wherein the switch is configured to enable selective operation of the convertible window assembly as a horizontal slider window when the frame is in a horizontal orientation and as a hung window when the frame is in a vertical orientation, the switch configured to selectively operate in an engaged position and a disengaged position, wherein:
in the engaged position, the switch is configured to interact with at least one of the notches to restrict slidable movement of the sash in at least one direction along the length of the frame; and
in the disengaged position, the switch is disengaged from the guide so as to allow unrestricted slidable movement of the sash along the length of the frame.

9. The convertible window assembly of claim 8, wherein:
the plurality of frame members comprises a first frame member and a second frame member parallel to the first frame member;
the guide comprises a first guide member disposed along at least a portion of an inner surface of the first frame member, and a second guide member disposed along at least a portion of an inner surface of the second frame member;
the switch comprises a first switch removably coupleable to the sash proximate the first guide, and a second switch removably coupleable to the sash proximate the second guide.

10. The convertible window assembly of claim 8, wherein:
in the engaged position, the switch is configured to interact with at least one of the notches to restrict downward vertical sliding of the sash when the frame is in the vertical orientation.

11. The convertible window assembly of claim 8, wherein:
in the disengaged position, horizontal sliding of the sash along the length of the frame is unrestricted when the frame is in the horizontal orientation.

12. The convertible window assembly of claim 8, wherein:
the switch is biased to contact the guide.

13. The convertible window assembly of claim 12, wherein:
the switch is spring-loaded.

14. The convertible window assembly of claim 12, wherein:
the switch comprises a switch housing removably coupleable to the sash and a user-actuated member movably positioned within the switch housing, the user-actuated member being movable relative to the switch housing between the engaged position and the disengaged position, wherein the user-actuated member is biased to contact the guide.

15. The convertible window assembly of claim 8, wherein:
the switch comprises a locking feature configured to selectively secure the switch in at least one of the engaged position and the disengaged position.

16. The convertible window assembly of claim 15, wherein:
the locking feature comprises a rotatable lock configured to secure the switch in at least one of the engaged position and the disengaged position.

17. The convertible window assembly of claim 8, wherein:
each of the plurality of notches comprises a planar surface extending laterally relative to the guide and an angled surface extending from the planar surface in a longitudinal direction relative to the guide.

18. The convertible window assembly of claim 8, further comprising:
a plurality of drainage holes positioned proximate adjacent ends of the plurality of frame members.

19. The convertible window assembly of claim 8, wherein:
the guide is removably insertable within the frame.

20. The convertible window assembly of claim 8, wherein:
the guide is integral to the frame.
